(19) United States
(12) Patent Application Publication
(10) Pub. No.: US 2021/0185952 A1
(43) Pub. Date: Jun. 24, 2021

(54) HYDROPONIC NUTRIENT SOLUTION AERATION DEVICE

(71) Applicant: Flow-Rite Controls, Ltd., Byron Center, MI (US)

(72) Inventor: Daniel N. Campau, Ada, MI (US)

(21) Appl. No.: 16/719,420

(22) Filed: Dec. 18, 2019

(51) Int. Cl. A01G 31/02

(52) U.S. Cl. CPC A01G 31/02

(57) ABSTRACT

The specification discloses a hydroponic nutrient solution aeration device that has no moving parts. The aeration device includes an aerator and a converging nozzle. The aerator includes a nutrient inlet, an air inlet port, and a diverging nozzle. The converging nozzle is adjacent the diverging nozzle. The largest portion of the converging nozzle is connected to the largest portion of the diverging nozzle. The aeration device uses a relatively small volume flow rate to entrain a significant amount of air.

### BACKGROUND

The present invention relates to hydroponic nutrient solution circulation systems, and more particularly to aeration devices for such systems.

Hydroponics is the method of growing plants without soil, using a solution of water and dissolved mineral and/or organic nutrients. Only the roots are immersed in the nutrient solution, and sometimes only the tips of the roots are immersed. Because soil nutrients are not available to the plants, it is critical that all of the necessary nutrients be added and maintained in the correct ratios in the nutrient solution. Hydroponic nutrient solutions must be monitored to ensure that nutrient concentration, oxygen concentration, pH, and temperature are within desired ranges.

Hydroponic systems are widely used by hobbyists and commercial growers. Growers employ a number of techniques to enable the plant roots to have access to oxygen. For example, it is common practice to bubble air through the nutrient solution so that the solution absorbs sufficient oxygen to meet plant needs. Air pumps and air stones, the same as those used in aquariums, are used for this purpose. However, air pumps, air stones, and associated air lines require maintenance and do not consistently provide sufficient oxygen to the plant roots. For another example, in a multiple grow tank environment, it is common practice to provide aeration using a large air pump feeding a distribution manifold so that air may be delivered to each grow tank. However, these techniques require air pumps and air lines routed to all of the grow tanks, all of which adds cost and complexity.

Alternatives to air pumps for aeration exist, but these alternatives create problems when used in multiple tank recirculation systems. Pumps fitted with a venturi aspirate air and mix it with the nutrient solution. However, these pumps are too large and too expensive to connect to each grow tank to circulate individual tank nutrient solution. If a large single venturi pump is used to augment nutrient aeration and circulation, it may increase the flow rate beyond the grow tank drain capacity; or it may not provide sufficient oxygen if flow is limited.

An aerator for the hydroponic field is disclosed in U.S. patent application Ser. No. 16/057,116 filed Aug. 7, 2018 and entitled “Hydroponic Nutrient Aeration and Flow Control Device and System” (assigned to the present Applicant). This aerator addresses the need for a device which can replace air bubblers and air pumps while delivering to each grow tank nutrient and air mixed in a one-to-one ratio by volume. However, the desire continues for products with even further improved efficacy, efficiency, and simplicity.

Separate and apart from the hydroponic field, aerators are used in marine livewells and baitwells, and are designed to operate in the range of 500 GPH (gallons per hour) to 750 GPH or more. Flow-Rite Controls, Ltd. (the present Applicant) manufactures and sells several models of such aerators, including PowerStream™, PowerJet™ and PowerStream Nozzle™ products. However, these products (a) are impractical to circulate individual grow tank nutrient each with its own pump and (b) are problematic if mounted to each grow tank and supplied by a system pump. At flow rates sufficiently high to provide adequate air, the flow into the grow tanks would exceed the drain capacity, leading to uneven nutrient levels and possible overflows.

### SUMMARY

The aforementioned issues are addressed by the present invention comprising a hydroponic nutrient solution aeration device of improved simplicity and efficiency. The aeration device includes an aerator and a converging nozzle. The aerator includes a nutrient inlet, and air inlet port, and a diverging nozzle. The converging nozzle defines a mixing chamber in fluid communication with the diverging nozzle. Preferably, the largest portion of the converging nozzle is connected to the largest portion of the diverging nozzle.

The aeration device is highly efficient because it uses a relatively small volume flow rate to entrain a significant amount of air. Consequently, a small pump can operate multiple aerator units serving multiple grow tanks.

These and other advantages and features of the invention will be more fully understood and appreciated by reference to the description of the current embodiment and the drawings.

### BRIEF DESCRIPTION OF THE DRAWINGS

FIG. 1 is a perspective view of the hydroponic nutrient solution aeration device in accordance with one embodiment of the invention.

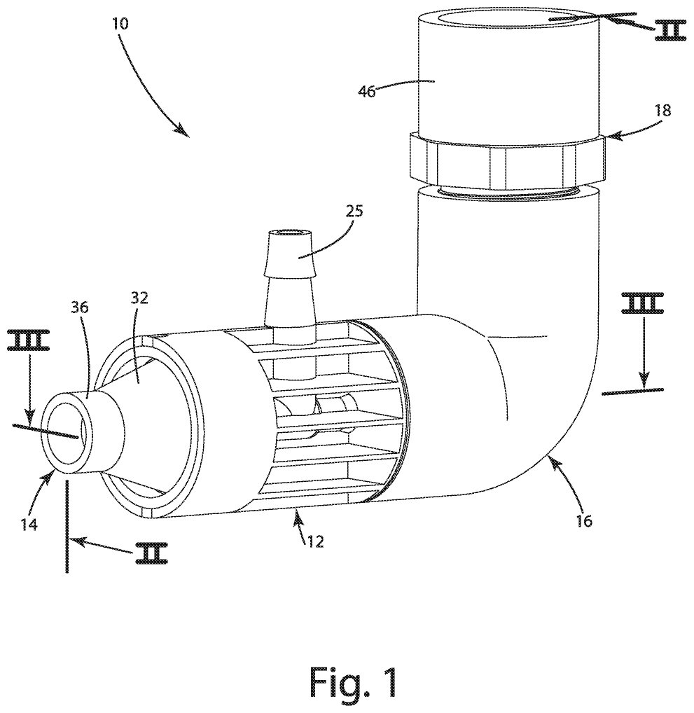

FIG. 2 is a sectional view taken along line II-II in FIG. 1.

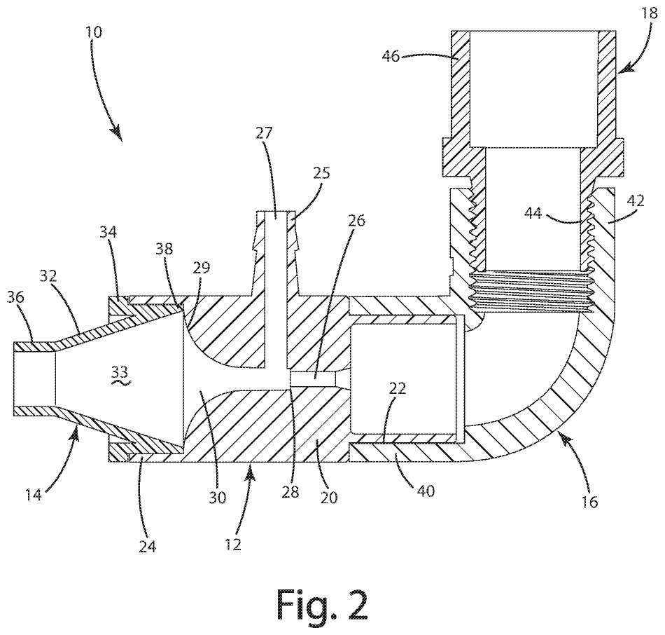

FIG. 3 is a sectional view taken along line III-III in FIG. 1.

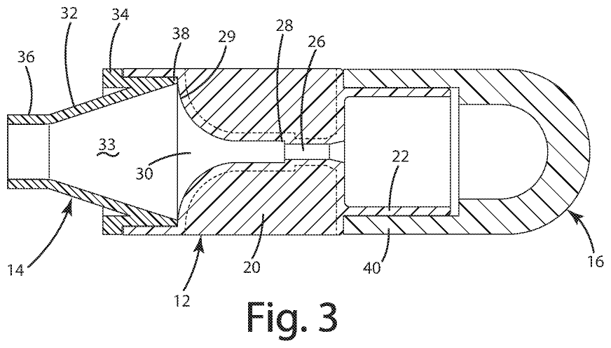

FIG. 4 is an enlarged sectional view of the aeration device, additionally showing the flow pattern through the device.

FIG. 5 is a perspective view showing the aeration device in a hydroponic grow tank

### DESCRIPTION OF THE CURRENT EMBODIMENT

### I. Introduction

Before the embodiments of the invention are described, it is to be understood that the invention is not limited to the details of operation or to the details of construction; and the arrangement of the components set forth in the following description or illustrated in the drawings. The invention may be implemented in various other embodiments and may be practiced or carried out in alternative ways not expressly disclosed herein.

In addition, it is to be understood that the phraseology and terminology used herein are for the purpose of description and should not be regarded as limiting. The use of “including” and “comprising” and variations thereof encompasses the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one or more of X, Y or Z individually, and any combination of any one or more of X, Y and Z, for example, X, Y, Z; X, Y; X, Z ; and Y, Z.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

### II. Nutrient Solution Aeration Device

A hydroponic nutrient aeration device constructed in accordance with a preferred embodiment of the invention is illustrated in the drawings and generally designated 10. The aeration device 10 includes an aerator 12, a converging nozzle 14, an elbow 16, and a fitting 18.

The aerator 12 includes a body portion 20, a male connector portion 22, a female connector portion 24, and an air inlet port 25. The air inlet port defines an air inlet passage 27. The body 20 defines a nutrient jet nozzle 26, which is coaxial with the male connector portion 22. The nutrient jet nozzle 26 has a step function increase in diameter at point 28, which is just ahead of the intersection of the nutrient jet nozzle 26 and the air inlet passage 27. The body further defines a diverging nozzle 30 or flair, which increases in size or diameter with increasing distance from the nutrient jet nozzle 26. The diverging nozzle end 29 is generally opposite the male connector portion 22. The diameter of the diverging nozzle end 29 is larger than the diameter of any other portion of the diverging nozzle.

The converging nozzle 14 includes a conical portion 32, a collar 34, and an outlet 36. The collar 34 surrounds the conical portion 32 and fits within the female connector portion 24 of the aerator 12. The converging nozzle 14 is secured within the aerator 12 using one or more known techniques, such as adhesives and/or ultrasonic welding. The conical portion 32 increases in diameter from the outlet 36 to the conical end 38. Consequently, the diameter of the outlet 36 is no larger than any diameter along the conical portion 32.

The elbow 16 includes a smooth connector portion 40 and any internally threaded connector portion 42. The male connection portion 22 of the aerator 12 fits within the female connector portion 40 of the elbow 16. The aerator 12 and the elbow 16 may be intersecured using one or more techniques, such as adhesives and/or ultrasonic welding.

The fitting 18 includes an externally threaded portion 44 and a mail connection portion 46. The externally threaded portion 44 may be secured within the internally threaded portion 42 of the elbow 16. The male connector portion 46 may be used to receive lines.

III. Hydroponic System with the Aeration Device

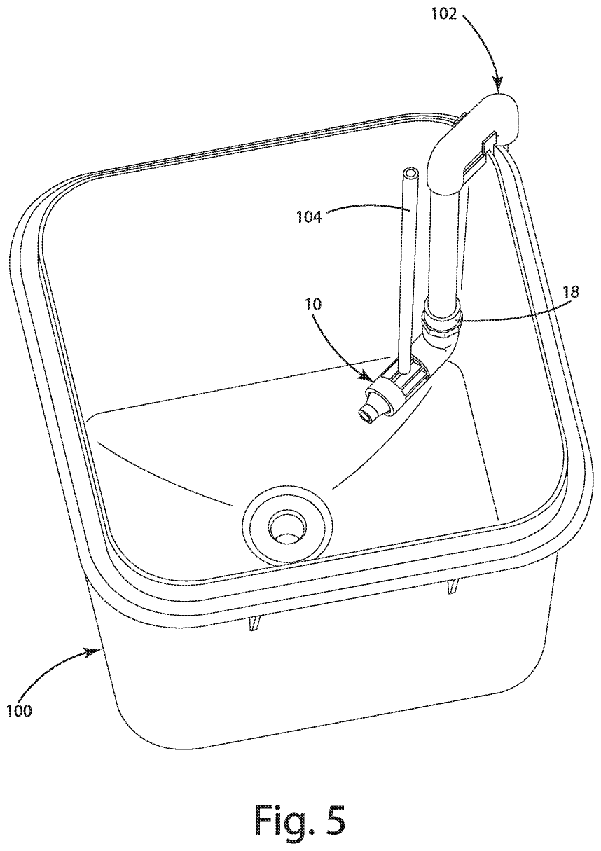

FIG. 5 illustrates the aeration device 10 within a grow tank 100. The grow tank may be of the any conventional design and configuration, and the grow tank may be one of a plurality of grow tanks within a larger system. Reference is again made to U.S. patent application Ser. No. 16/057,116 filed Aug. 7, 2018 and entitled “Hydroponic Nutrient Aeration and Flow Control Device and System” (assigned to the present Applicant), the disclosure of which is incorporated by reference. This application discloses exemplary systems within which the present aeration device 10 may be used.

The nutrient inlet 46 of the fitting 18 is connected to a nutrient supply line 102. The air inlet port 25 is connected to an air supply line 104 having an end above the level of the nutrient solution within the tank 100.

When the aeration device 10 is positioned near the bottom of the grow tank 100, the stream of aerated nutrient solution and air bubbles can be introduced (a) near the center of the grow tank 100 (e.g. for single plant tanks) or (b) can be directed tangentially to create a circulation of aerated nutrient solution to all regions of the grow tank (e.g. to reach multiple plants). Alternatively, the aeration device 10 can also be installed in a bulkhead fitting in the side of the grow tank 100.

### IV. Operation

The aeration device 10 is simple and efficient. Rather than restrict flow as might seem likely, the converging nozzle 14 enhances the aspiration strength and creates a strong circulation region in which nutrient solution and air mix thoroughly prior to exiting into the grow tank 100. This method of mixing air and liquid within the aeration device enhances the absorption rate and maintains sufficient jet momentum so the exit flow reaches well into the root mass of the plants within the tank 100.

Nutrient solution under pressure from the recirculation pump (not shown) enters the aeration device 10 through the nutrient inlet 18. A jet of liquid nutrient exits the nutrient jet nozzle 26 and entrains air through air inlet port 25. The nutrient solution and entrained air enter the mixing chamber 33 within the converging nozzle 14, which causes the nutrient solution and the entrained air to circulate within the mixing chamber 33, increasing both the time and the surface area of contact for enhanced air/oxygen absorption before the solution/air mixture exits into the grow tank 100 through the converging nozzle outlet 36.

The aeration device 10 differs from venturi-type aerators in that the vacuum is created by a separation in the flow as a result of the step increase at point 28 in the diameter the jet stream nozzle 26 exit. A low pressure region is created which fills with air drawn in through the air inlet port 25. The air surrounds the jet of nutrient solution exiting the nutrient jet nozzle 26. The air flows along with the jet of nutrient solution through the diverging nozzle 30 and into the mixing chamber 33 of the converging nozzle 14. Here the air and nutrient solution continue to mix until they exit the converging nozzle 14 through the outlet 36 and into the tank 100. The nutrient solution jet maintains substantial momentum along the path between the nutrient solution jet 26 and the outlet 36, which enhances the mixing of air and the nutrient solution and propels the mixture to remote regions of the grow tank.

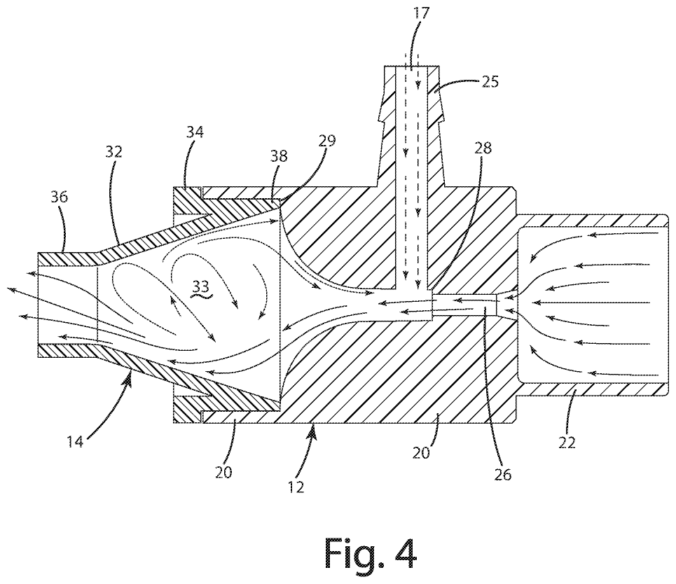

FIG. 4 shows the eddy which develops at the nutrient jet and air inlet intersection. This is a low pressure region which enhances both the aspiration and mixing effects.

The aeration device 10 is highly efficient because it uses a small volume flow rate to entrain a significant amount of air. This means a small pump can operate multiple aeration devices 10 serving multiple grow tanks 100.

The aeration device 10 delivers high aeration nutrient solution to the grow tanks 100, and the device can be easily retrofitted to existing circulating systems without exceeding drain capacity.

### V. Conclusion

The above descriptions are those of current embodiments of the invention. Various alterations and changes can be made without departing from the spirit and broader aspects of the invention as defined in the appended claims, which are to be interpreted in accordance with the principles of patent law including the doctrine of equivalents.

This disclosure is illustrative and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as alternatives.

Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A hydroponic nutrient circulation system comprising:
a nutrient reservoir;
a plurality of grow tanks;
a nutrient supply system for supplying nutrient from the nutrient reservoir to the grow tanks, the nutrient supply system including a nutrient supply line extending to each grow tank;
a nutrient return system for returning nutrient from the grow tanks to the nutrient reservoir, the nutrient return system including a nutrient return line extending from each grow tank;
an air supply line extending into each grow tank; and
a plurality of aeration devices, each within one of the grow tanks and including:
a nutrient inlet connected to the associated nutrient supply line;
an air inlet port connected to the associated air supply line;
a diverging nozzle in fluid communication with the nutrient inlet and the air inlet port; and
a converging nozzle in fluid communication with the diverging nozzle, the converging nozzle defining a mixing chamber, the converging nozzle including an outlet in fluid communication with the mixing chamber, the outlet having a smaller diameter than any diameter of the mixing chamber.

2. A hydroponic nutrient circulation system as defined in claim 1 wherein:
each diverging nozzle has a diverging end portion having a largest diverging internal diameter; and
each converging nozzle has a converging end portion having a largest converging internal diameter, the converging end portion being adjacent to and communicating with the diverging end portion.

3. A hydroponic nutrient circulation system as defined in claim 2 wherein the largest diverging internal diameter and the largest converging internal diameter are equal.

4. A hydroponic nutrient circulation system as defined in claim 1 wherein each mixing chamber is conical.

5. A hydroponic nutrient circulation system as defined in claim 1 wherein each outlet has a diameter no larger than any diameter of the mixing chamber.

6. A hydroponic nutrient aeration device comprising:
a nutrient inlet connected to the associated nutrient supply line;
an air inlet port connected to the associated air supply line;
a diverging nozzle in fluid communication with the nutrient inlet and the air inlet port; and
a converging nozzle in fluid communication with the diverging nozzle, the converging nozzle defining a mixing chamber, the converging nozzle including an outlet in fluid communication with the mixing chamber, the outlet having a smaller diameter than any diameter of the mixing chamber.

7. A hydroponic nutrient circulation system as defined in claim 6 wherein:
the diverging nozzle has a diverging end portion having a largest diverging internal diameter; and
the converging nozzle has a converging end portion having a largest converging internal diameter, the converging end portion being adjacent to and communicating with the diverging end portion.

8. A hydroponic nutrient circulation system as defined in claim 7 wherein the largest diverging internal diameter and the largest converging internal diameter are equal.

9. A hydroponic nutrient circulation system as defined in claim 6 wherein each mixing chamber is conical.

10. A hydroponic nutrient circulation system as defined in claim 6 wherein each outlet has a diameter no larger than any diameter of the mixing chamber.
